(19) United States
(12) Patent Application Publication
(10) Pub. No.: US 2010/0089423 A1
(43) Pub. Date: Apr. 15, 2010

(54) CLEANING METHOD AND STORAGE MEDIUM

(75) Inventors: Kiyohito IIJIMA, Nirasaki City (JP); Masahiro Numakura, Nirasaki City (JP); Hiroaki Mochizuki, Nirasaki City (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOKYO ELECTRON LIMITED, Tokyo (JP)

(21) Appl. No.: 12/577,347

(22) Filed: Oct. 12, 2009

(30) Foreign Application Priority Data
Oct. 15, 2008 (JP) 2008-266453

(51) Int. Cl. B08B 9/00

(52) U.S. Cl. 134/22.1

(57) ABSTRACT

A cleaning method is provided to clean processing chambers of a substrate processing apparatus for transferring substrates included in each of lots to the processing chambers on a lot basis and processing the substrates in the processing chambers simultaneously. The cleaning method includes checking whether a lot is switched to another lot to which different cleaning conditions are applied prior to the processing in the processing chambers, performing a cleaning process on the processing chambers under cleaning conditions of a previous lot by transferring cleaning substrates into the processing chambers when it is determined that a lot is switched to another lot to which different cleaning conditions are applied, and omitting the cleaning process of the processing chambers when it is determined that a lot is switched to another lot to which the same cleaning conditions are applied.

### FIELD OF THE INVENTION

The present invention relates to a cleaning method for cleaning an interior of a processing chamber installed in a substrate processing apparatus and a storage medium.

### BACKGROUND OF THE INVENTION

In a manufacturing process of semiconductor devices, various processes such as etching, film formation and the like are performed for various purposes on a semiconductor wafer or a substrate such as a glass substrate for use in a flat panel display (FPD) or the like under different processing conditions. For example, in a substrate processing apparatus such as a plasma processing apparatus or the like, a plurality of substrates are processed continuously.

In this substrate processing apparatus, an interior of a processing chamber is cleaned at a predetermined timing to properly remove reaction products deposited on an inner wall of the processing chamber and the like during the processing or particles such as fine particles (fine foreign substances) flowing into the processing chamber from the outside.

However, even when the cleaning is performed under the same cleaning conditions, the cleaning may be excessive or insufficient. For example, insufficient cleaning leads to generation of particles in the processing chamber, or excessive cleaning prohibits optimization of the state in the processing chamber (e.g., the amount of reaction products adhered to the inner wall, a temperature in the processing chamber, or the like), thereby affecting the processing. This may result in quality deterioration of semiconductor devices formed on the substrate.

Therefore, the inventors of the present invention have suggested a technique (see, e.g., Patent Document 1) capable of properly cleaning the interior of the processing chamber under cleaning conditions set depending on types of processes (e.g., a process for controlling a state in the processing chamber, an etching process and the like) upon completion of the corresponding processes.

[Patent Document 1] Japanese Patent Laid-open Publication No. 2007-250791

When a plurality of substrates are transferred on a lot basis to the processing chamber so as to be processed, cleaning may be performed at a timing of switching lots. For example, when a lot is switched to another lot to which different processing conditions are applied, it is preferable to control the state in the processing chamber by cleaning.

However, even when the interior of the processing chamber is cleaned under different cleaning conditions, the cleaning cannot be properly performed. Namely, the cleaning conditions applied to the previous lot are different from those applied to the switched lot. Thus, deposits deposited in the processing chamber by the processing prior to the switching operation cannot be removed under the cleaning conditions of the switched lot.

Further, when several lots are processed in a plurality of processing chambers simultaneously, the number of substrates processed in each of the processing chambers is smaller compared to a case in which substrates are processed in a single processing chamber. Therefore, if the cleaning is performed whenever a lot is switched to another lot, the cleaning may be excessively carried out.

### SUMMARY OF THE INVENTION

In view of the above, the present invention provides a cleaning method capable of performing cleaning under proper cleaning conditions and at a proper timing of switching lots.

In accordance with a first aspect of the present invention, there is provided a cleaning method for cleaning processing chambers of a substrate processing apparatus for transferring substrates included in each of lots to the processing chambers on a lot basis and processing the substrates in the processing chambers simultaneously, the substrate processing apparatus including a storage unit for storing processing conditions of the lots and cleaning conditions set in accordance with the processing conditions, the method comprising: checking whether a lot is switched to another lot to which different cleaning conditions are applied prior to the processing in the processing chambers; performing a cleaning process on the processing chambers under cleaning conditions of a previous lot by transferring cleaning substrates into the processing chambers when it is determined that a lot is switched to another lot to which different cleaning conditions are applied; and omitting the cleaning process of the processing chambers when it is determined that a lot is switched to another lot to which the same cleaning conditions are applied.

In accordance with a first aspect of the present invention, there is provided a computer readable storage medium storing a program for executing on a computer a cleaning method for cleaning processing chambers of a substrate processing apparatus for transferring substrates included in each of lots to the processing chambers on a lot basis and processing the substrates in the processing chambers simultaneously, wherein the substrate processing apparatus includes a storage unit for storing processing conditions of the lots and cleaning conditions set in accordance with the processing conditions, and wherein the method includes: checking whether a lot is switched to another lot to which different cleaning conditions are applied prior to the processing in the processing chambers; performing a cleaning process on the processing chambers under cleaning conditions of a previous lot by transferring cleaning substrates into the processing chambers when it is determined that a lot is switched to another lot to which different cleaning conditions are applied; and omitting the cleaning process of the processing chambers when it is determined that a lot is switched to another lot to which the same cleaning conditions are applied.

In accordance with the aspects of the present invention, when a lot is switched to another lot to which different cleaning conditions are applied in each of the processing chambers where a plurality of substrates are processed simultaneously, the interior of the processing chamber is cleaned. In this case, the cleaning is performed under the cleaning conditions of the previous lot instead of those of the switched lot. Accordingly, deposits deposited on the inner wall of the processing chamber and the like by the processing of the previous lot can be effectively removed, and the switched lot can be properly processed.

On the other hand, when a lot is switched to another lot to which the same conditions are applied, the interior of the processing chamber is not cleaned. In this case, since the substantially same processing is performed on the switched lot, it is often unnecessary to clean the interior of the processing chamber. Moreover, when the processing is carried out in a plurality of processing chambers simultaneously, the cleaning in each of the processing chambers can be prevented from being excessively performed. Namely, in accordance with the aspects of the present invention, the cleaning can be performed under proper cleaning conditions and at a proper timing of switching lots.

Further, the cleaning process may be performed for a cleaning time calculated in accordance with the number of times of the processing of the substrates. Since the cleaning time can be set in accordance with the actual number of times of the processing, the cleaning can be properly performed without becoming excessive or insufficient. Especially, when the processing is performed in a plurality of processing chambers simultaneously, even if an excessive number of substrates are processed in a processing chamber due to breakdown or the like of another processing chamber, the cleaning can be performed without being excessive or insufficient. This is because the cleaning time is set in accordance with the number of times of the processing.

Further, the storage unit may store group data in which the processing conditions of the lots are classified into groups based on the cleaning conditions corresponding thereto, and whether a lot may be switched to another lot to which different cleaning conditions are applied is determined depending on whether the processing conditions of the lots belong to different cleaning groups classified based on the group data. Namely, whether or not a lot is switched to another lot to which different cleaning conditions are applied can be determined simply by determining whether or not the processing conditions of the switched lot belong to the different cleaning group.

Further, the cleaning process may be performed, in addition to the cleaning process performed at a timing of switching lots, by transferring the cleaning substrates into the processing chambers at a timing at which the number of times of the processing performed in the processing chambers under the same processing conditions reaches a preset number. Accordingly, even when several lots to which the same processing conditions are applied are processed continuously without performing the cleaning at a timing of switching lots, the cleaning is carried out when the number of times of the processing reaches a predetermined number. Thus, the interior of each processing chamber can be maintained under the proper conditions constantly.

Further, when the timing of the cleaning process performed at the timing of switching lots overlaps with the timing of the cleaning process calculated in accordance with the number of times of the processing, the cleaning process may be performed at the timing calculated in accordance with the number of times of the processing without being performed at the timing of switching lots. Accordingly, the excessive cleaning can be prevented.

In the specification, 1 mTorr and 1 sccm indicate (10⁻³×101325/760) Pa and (10⁻⁶/60) m³/sec, respectively.

In accordance with the aspects of the present invention, the cleaning can be performed under proper cleaning conditions and at a proper timing of switching lots.

### BRIEF DESCRIPTION OF THE DRAWINGS

The other objects and features of the present invention will become apparent from the following description of embodiments, given in conjunction with the accompanying drawings, in which:

FIG. 1 shows a cross sectional view of a schematic configuration of a substrate processing apparatus capable of performing a cleaning method in accordance with an embodiment of the present invention;

FIG. 2 describes a cross sectional view of a configuration example of a plasma processing apparatus PM shown in FIG. 1;

FIG. 3 provides a block diagram of a configuration example of a control unit illustrated in FIG. 1;

FIG. 4 presents a specific example of a cleaning condition data table;

FIG. 5 represents a specific example of a group data table;

FIG. 6 offers a flowchart showing a specific example of a cleaning process in accordance with the embodiment of the present invention;

FIG. 7 is a flowchart showing a specific example of the contents of the cleaning process shown in FIG. 6;

FIG. 8 explains a specific example of processing of lots in processing chambers of plasma processing apparatuses and a cleaning timing;

FIG. 9 explains a specific example of processing of lots in processing chambers of plasma processing apparatuses and a cleaning timing; and

FIG. 10 explains a specific example of processing of lots in processing chambers of plasma processing apparatuses and a cleaning timing.

### DETAILED DESCRIPTION OF THE EMBODIMENT

The embodiments of the present invention will be described with reference to the accompanying drawings which form a part hereof. Throughout the specification and drawings, like reference numerals will be given to like parts having substantially the same function and configuration, and redundant description thereof will be omitted.

### (Configuration Example of Substrate Processing Apparatus)

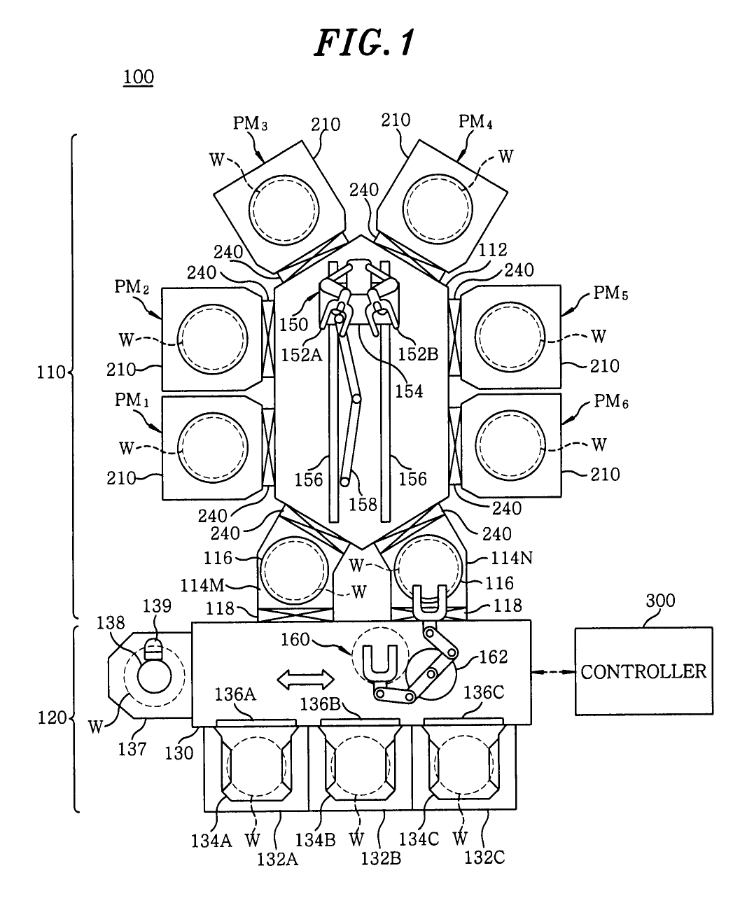

First of all, a substrate processing apparatus for performing a substrate processing method in accordance with an embodiment of the present invention will be described with reference to the drawings. FIG. 1 provides a cross sectional view showing a schematic configuration of the substrate processing apparatus. A substrate processing apparatus 100 includes a processing unit 110 having a plurality of (six in this embodiment) plasma processing apparatuses PM₁ to PM₆ for performing predetermined processes on a substrate, e.g., a semiconductor wafer W, a transfer unit 120 for loading/unloading the wafer W to/from the processing unit 100 under an atmospheric pressure, and a control unit 300 for controlling an entire operation of the substrate processing apparatus 100.

Here, each of the plasma processing apparatuses PM₁ to PM₆ is configured as, e.g., a plasma etching apparatus. The plasma processing apparatuses PM₁ to PM₆ have the same configuration. That is, each of the plasma processing apparatuses PM₁ to PM₆ has a processing chamber 210, and is configured to perform a plasma etching process on a surface of a wafer W by generating a plasma of a processing gas on the wafer W placed in the processing chamber 210. A specific configuration example of the plasma processing apparatuses PM₁ to PM₆ will be described later.

Although FIG. 1 shows an example in which the substrate processing apparatus 100 includes six plasma processing apparatuses, there may be provided five or less plasma processing apparatuses without being limited to the above example. Further, the substrate processing apparatus 100 shown in FIG. 1 does not necessarily include the same plasma processing apparatuses, and may include processing apparatuses (e.g., a heat treating apparatus, a film forming apparatus and the like) for performing processes other than an etching process.

A transfer chamber 130 of the transfer unit 120 is configured as a box-shaped body having a substantially rectangular cross section, in which clean air or nonreactive gas, e.g., N₂ gas or the like, is circulated. A plurality of cassette stands 132A to 132C are arranged side by side at one long side of the transfer chamber 130 having the substantially rectangular cross section. Cassette containers 134A to 134C are mounted on the cassette stands 132A to 132C. Three loading ports 136A to 136C serving as input ports of wafers W are installed at the sidewall of the transfer chamber 130 so as to correspond to the cassette stands 132A to 132C.

Although the three cassette containers 134A to 134C are respectively mounted on the cassette stands 132A to 132C in FIG. 1, the number of cassettes stands or cassette containers is not limited thereto and may be one, two, or more than three.

Each of the cassette containers 134A to 134C can accommodate therein wafers W of at least one lot (e.g., 25 wafers) in multiple levels at an equal pitch, and the inside thereof is sealed and filled with, e.g., an N₂ gas atmosphere. Further, the wafers W are loaded to and unloaded from the transfer chamber 130 via the loading ports 136A to 136C.

Here, each of the cassette containers 134A to 134C accommodates therein wafers W of each lot. Specifically, product wafers Wp of one lot (e.g., 25 wafers) used in an etching process, a plurality of controlling wafers Wd used in controlling the state in each of the processing chambers 210 prior to the etching process, and a plurality of cleaning wafers Wf used in cleaning the interior of each of the processing chambers 210 are accommodated in the cassette containers 134A to 134C. The product wafers Wp accommodated in the cassette containers 134A to 134C may belong to a lot of wafers which are processed under the same processing conditions or to a lot of wafers which are processed under different processing conditions.

Further, any type of wafers may be accommodated in any one of the cassette containers 134A to 134C. For example, each of the cassette containers 134A to 134C may accommodate therein all types of the production wafers Wp, the controlling wafers Wd and the cleaning wafers Wf.

A transfer unit-side transfer mechanism 160 formed of a multi-joint arm capable of contracting, extending, elevating and revolving is installed in the transfer chamber 130. The transfer unit-side transfer mechanism 160 is configured to transfer a wafer W in a longitudinal direction of the transfer chamber 130 (shown by an arrow in FIG. 1). Specifically, the transfer unit-side transfer mechanism 160 is fixed on a stand 162, and the stand 162 can slidably move on a guide rail (not shown) installed at a central portion of the transfer chamber 130 in the longitudinal direction thereof by, e.g., a linear motor driving mechanism. The transfer unit-side transfer mechanism 160 may be, e.g., a double-arm mechanism having two picks as shown in FIG. 1 or a single-arm mechanism having one pick.

An orienter (pre-alignment stage) 137 serving as a positioning device of the wafer W is installed at one end portion of the transfer chamber 130, i.e., one short side of the transfer chamber 130 having the substantially rectangular cross section. The orienter 137 has, e.g., a rotatable table 138 and an optical sensor 139 for optically detecting a peripheral portion of the wafer W, and performs position alignment by detecting an orientation flat or a notch of the wafer W.

Next, a configuration example of the processing unit 110 will be described. Since the substrate processing apparatus 100 in accordance with this embodiment has a cluster tool type structure, the processing unit 110 includes a common transfer chamber 112 having a polygonal (e.g., hexagonal) cross section as illustrated in FIG. 1. The plasma processing apparatuses PM₁ to PM₆ are arranged around the common transfer chamber 112 and connected thereto via respective gate valves 240.

Further, front ends of a first and a second load-lock chamber 114M and 114N are connected to the common transfer chamber 112 via gate valves (vacuum side gate valves) 240, and rear ends of the first and the second load-lock chamber 114M and 114N are connected to the other long side of the transfer chamber 130 having a substantially rectangular cross section via gate valves (atmospheric side gate valves) 118.

A pressure in the common transfer chamber 112 can be controlled to a predetermined vacuum level. The wafer W can be transferred through the common transfer chamber 112 between the processing chambers 210 of the plasma processing apparatuses PM₁ to PM₆ or between the processing chambers 210 and the first and the second load-lock chambers 114M and 114N.

Each of the first and the second load-lock chambers 114M and 114N temporarily holds a wafer W such that the wafer W is delivered after pressure adjustment. Exchanging stands 116 capable of mounting thereon wafers W are respectively installed inside the first and the second load-lock chambers 114M and 114N.

A processing unit-side transfer mechanism 150 formed of, e.g., a multi-joint arm capable of contracting, extending, elevating and revolving is installed inside the common transfer chamber 112. The processing unit-side transfer mechanism 150 has two picks 152A and 152B so as to handle two wafers W at the same time.

The processing unit-side transfer mechanism 150 is rotatably supported on a stand 154. The stand 154 slidably moves on a guide rail 156 disposed from the front side to the rear side in the common transfer chamber 112 by, e.g., a slide driving motor (not illustrated). Further, the stand 154 is connected to a flexible arm 158 for passing therethrough, e.g., wiring of a motor for revolving an arm or the like.

The processing unit-side transfer mechanism 150 slides along the guide rail 156 to thereby have access to the first and the second load-lock chamber 114M and 114N and the processing chambers 210 of the plasma processing apparatuses PM₁ to PM₆. For example, when the processing unit-side transfer mechanism 150 is made to have access to the first and the second load-lock chambers 114M and 114N and the processing chambers 210 of the plasma processing apparatuses PM₁ and PM₆ facing each other, the processing unit-side transfer mechanism 150 moves along the guide rail 156 to be positioned at the rear side of the common transfer chamber 112.

Further, when the processing unit-side transfer mechanism 150 is made to have access to the processing chambers 210 of the four plasma processing apparatuses PM₂, PM₃, PM₄ and PM₅, the processing unit-side transfer mechanism 150 moves along the guide rail 156 to be positioned at the front side of the common transfer chamber 112. Accordingly, the access to the first and the second load-lock chambers 114M and 114N and all the processing chambers 210 connected to the common transfer chamber 112 can be realized by the single processing unit-side transfer mechanism 150.

Further, the processing unit-side transfer mechanism 150 may include two transfer units without being limited to the above configuration. In other words, a first and a second transfer unit, each having a multi-joint arm capable of contracting, extending, elevating and revolving, may be disposed at the rear side and the front side of the common transfer chamber 112, respectively. Furthermore, the processing unit-side transfer mechanism 150 does not necessarily have two picks. For example, it may have only a single pick.

### (Configuration Example of Plasma Processing Apparatus)

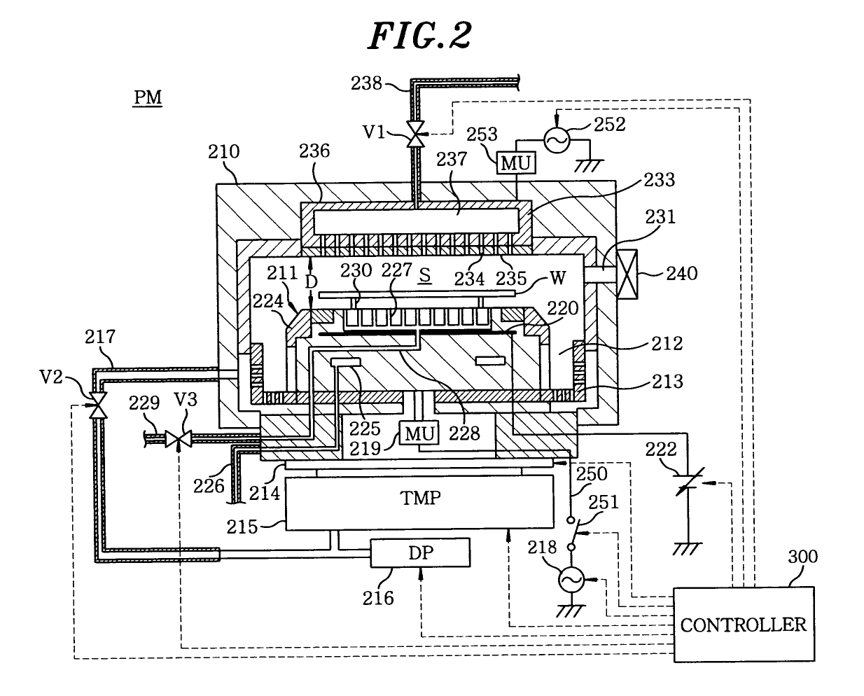

Hereinafter, the configuration example of the plasma processing apparatuses PM₁ to PM₆ will be described with reference to the drawings. The plasma processing apparatuses PM₁ to PM₆ have the same configuration, so that the plasma processing apparatus PM will be described representatively. FIG. 2 is a cross sectional view of a schematic configuration of the plasma processing apparatus PM. Here, the plasma processing apparatus PM is configured as, e.g., a parallel plate type plasma etching apparatus.

As shown in FIG. 2, the plasma processing apparatus PM includes a cylindrical processing chamber 210 made of metal, e.g., aluminum, stainless steel or the like. The processing chamber 210 has at a bottom portion thereof a susceptor 211 serving as a lower electrode. The susceptor 211 also serves as a stage for mounting thereon a wafer W. That is, the susceptor 211 is formed in a cylindrical shape, and can mount thereon a wafer W having a diameter of, e.g., 300 mm.

A gas exhaust path 212, which serves as a flow path for exhausting gas above the susceptor 211 to the outside of the processing chamber 210, is formed between the sidewall of the processing chamber 210 and the susceptor 211. A ring-shaped baffle plate 213 is disposed in the middle of the gas exhaust path 212. A lower space of the gas exhaust path 212, formed below the baffle plate 213, is connected to an adaptive pressure control (APC) valve 214 serving as a variable butterfly valve. The APC valve 214 is connected to a turbo molecular pump (TMP) 215 serving as a vacuum exhaust pump, and is also connected to a dry pump (DP) 216 serving as a gas exhaust pump via the TMP 215. A gas exhaust line (hereinafter, referred to as a “main exhaust line”) formed by the APC valve 214, the TMP 215 and the DP 216 decreases a pressure in the processing chamber 210 to a high vacuum level. Further, the pressure in the processing chamber 210 is controlled by the APC valve 214.

Further, the lower space of the gas exhaust path 212 formed below from the baffle plate 213 is also connected to another gas exhaust line (hereinafter, referred to as a “temporary suction line”) which is separated from the main exhaust line. The temporary suction line includes a gas exhaust pipe 217 provided with a valve V2 and a DP 216. Generally, the gas in the processing chamber 210 is exhausted by the temporary suction line in advance before it is exhausted by the main exhaust line.

The susceptor 211 serving as the lower electrode is connected to a high frequency power supply 218 via a conducting wire 250. The high frequency power supply 218 applies a predetermined high frequency power to the susceptor 211. The conducting wire 250 is provided with a matching unit (MU) 219 and a switch 251 for switching the conducting/non-conducting state of the conducting wire 50. The matching unit 219 matches a load impedance to an internal (or output) impedance of the high frequency power supply 218. The matching unit 219 serves to render the internal impedance of the high frequency power supply 218 and the load impedance be seemingly matched to each other when a plasma is generated in the processing chamber 210.

The switch 251 is positioned between the susceptor 211 and the high frequency power supply 218 to set the susceptor to any one of an electrically floating state and an electrically conducting state. For example, when the wafer W is not mounted on the top surface of the susceptor 211, the susceptor 211 is set to the electrically floating state by the switch 251.

A circular plate-shaped electrode plate 220, which is formed of a conductive film and electrostatically attracts and holds the wafer W, is disposed at an upper inner portion of the susceptor 11. A DC power supply 222 is electrically connected to the electrode plate 220. The wafer W is attracted and held on the top surface of the susceptor 211 by Coulomb force or Johnsen-Rahbek force produced by a DC voltage applied from the DC power supply 222 to the electrode plate 220. A circular ring-shaped focus ring 224 formed of silicon or the like converges a plasma produced above the susceptor 211 toward the wafer W.

A coolant path 225 is provided inside the susceptor 211. A coolant (e.g., cooling water) kept at a predetermined temperature is supplied from a chiller unit (not shown) to the coolant path 225 via a pipe 226 so as to be circulated therein. A process temperature of the wafer W mounted on the susceptor 211 is controlled by the coolant path 225.

A plurality of heat transfer gas supply holes 227 and heat transfer gas supply grooves (not shown) are disposed in a portion of the top surface of the susceptor 211 to which the wafer W is attracted (hereinafter, referred to as an “adsorption surface”). The heat transfer gas supply holes 27 and the heat transfer gas supply grooves are connected to a heat transfer gas supply unit (not shown) via a heat transfer gas supply line 228 disposed inside the susceptor 211 and a heat transfer gas supply pipe 229 provided with a valve V3. Accordingly, a heat transfer gas (e.g., He gas) is supplied into a gap between the adsorption surface and the bottom surface of the wafer W, thereby improving thermal conductivity between the wafer W and the susceptor 211. Further, the amount of the heat transfer gas supplied through the heat transfer gas supply holes 27 and the heat transfer gas supply grooves is controlled by using the valve V3.

Further, a plurality of pusher pins 230 serving as lift pins capable of protruding from the top surface of the susceptor 211 are provided at the adsorption surface. The pusher pins 230 move in a vertical direction in the drawing as a rotational movement of a motor (not shown) is converted into a linear movement by ball screws and the like. When the wafer W is attracted and held on the adsorption surface, the pusher pins 230 are retracted into the susceptor 211. When the wafer W that has been subjected to a predetermined process (e.g., an etching process) is unloaded from the processing chamber 210, the pusher pins 230 protrude from the top surface of the susceptor 211 so that the wafer W is lifted up from the susceptor 211.

An upper electrode 233 is disposed at a ceiling portion of the chamber 210. A high frequency power supply 252 is connected to the upper electrode 233 via a matching unit (MU) 253, and applies a predetermined high frequency power to the upper electrode 233. The matching unit 253 matches a load impedance to an internal (or output) impedance of the high frequency power supply 252, and serves to render the internal impedance of the high frequency power supply 253 and the load impedance be seemingly matched to each other when a plasma is generated in the processing chamber 210.

The upper electrode 233 also serves as a shower head for introducing a gas into the processing chamber. The upper electrode 233 includes an electrode plate 235 having a plurality of gas ventholes 234, and an electrode supporting member 236 for detachably supporting the electrode plate 235. A buffer room 237 is provided in the electrode supporting member 236, and is connected to a processing gas inlet pipe 238 extended from a processing gas supply unit (not shown). A valve V1 is installed in the middle of the processing gas inlet pipe 238, and controls the gas supply amount to the buffer room 237.

A gate valve 240 for opening and closing a loading/unloading port 231 of the wafer W is installed at the sidewall of the processing chamber 210. When the processing gas is supplied into the processing chamber 210 of the plasma processing apparatus PM and the high frequency power is applied to the upper electrode 233, a high-density plasma is generated in a plasma generating space S. As a consequence, ions and radicals are produced, thereby etching the wafer W.

Further, the plasma processing apparatus PM has a control unit 300 for controlling the entire operation of the apparatus. The control unit 300 controls the respective units based on predetermined programs and predetermined setting information, thereby performing, e.g., a control process for controlling the inner state of the processing chamber, an etching process, a cleaning process for cleaning the interior of the processing chamber and the like.

### (Configuration Example of Control Unit)

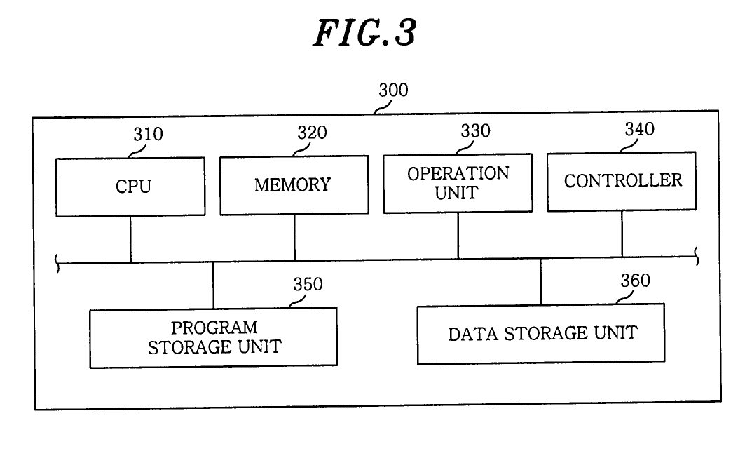

A specific configuration example of the control unit 300 will be described with reference to the drawings. As shown in FIG. 3, the control unit 300 includes a central processing unit (CPU) 310 forming a control unit main body and a memory 320 for temporarily storing data and the like used by the CPU 310 to control the respective units.

Further, the control unit 300 includes an operation unit 330 formed of a touch panel for displaying an operation screen, a selection screen or the like, various controllers 340 for controlling the respective units of the substrate processing unit 100, a program storage unit 350 for storing programs for performing the processes of the substrate processing apparatus 100, and a data storage unit 360 for storing various data such as recipes and the like used for performing the processes based on the programs.

Each of the program storage unit 350 and the data storage unit 360 includes a recording medium such as a flash memory, a hard disk or a CD-ROM, and data thereof are read out by the CPU 310 if necessary. Further, the CPU 310, the memory 320, the operation unit 330, the various controllers 340, the program storage unit 350 and the data storage unit 360 are electrically connected to each other via bus lines such as a control bus, a system bus, a data bus or the like.

The various controllers 340 include controllers for controlling the valves V1, V2 and V3, the APC valve 214, the TMP 215, the DP 216, the high frequency power supplies 218 and 252, the DC power supply 222, the switch 251 and the like.

The program storage unit 350 stores therein a transfer program for controlling transfer of a wafer and the like in addition to a processing program for performing, e.g., an etching process on a wafer or a control process for controlling the inner state of the processing chamber, and a cleaning program for cleaning the interior of the processing chamber.

The data storage unit 360 stores therein, e.g., processing conditions (etching conditions and conditions for controlling the inner state of the processing chamber), cleaning conditions and the like when the respective units are controlled based on the processing program, the cleaning program and the like. Such conditions are formed as recipes including, e.g., a pressure in the processing chamber, a gas flow rate, a high frequency power and the like. Further, the processing conditions are set for each lot. Therefore, when the processing of each lot is started, the preset processing conditions are read out, and wafers of a corresponding lot are processed based on the read-out processing conditions.

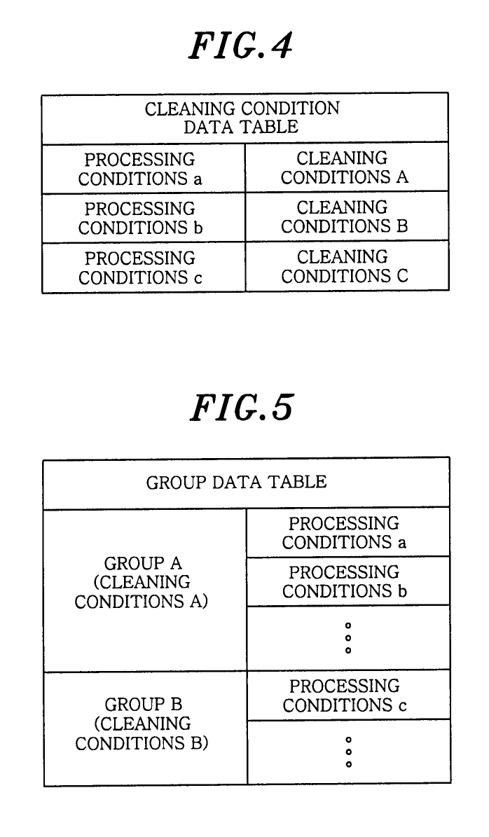

The data storage unit 360 stores therein, as cleaning setting data, data managed by a cleaning condition data table shown in FIG. 4 and a group data table illustrated in FIG. 5. In the cleaning condition data table shown in FIG. 4, cleaning conditions can be set in accordance with processing conditions. Referring to FIG. 4, the same cleaning conditions A are set under processing conditions a and b, whereas different cleaning conditions B are set under processing conditions c.

Further, in the group data table of FIG. 5, the processing conditions are classified into groups in accordance with the cleaning conditions corresponding thereto. That is, the processing conditions having the same cleaning conditions belong to the same cleaning group. In this case, the processing conditions a and b of lots a and b are associated with the same cleaning conditions A, and thus belong to the same group A. On the other hand, the processing conditions c of lot c are associated with different cleaning conditions B, and thus belongs to different group B. The groups may be managed on a group name basis as shown in FIG. 5, or on a directory basis.

Whether or not a lot is switched to another lot to which different cleaning conditions are applied can be determined in accordance with the cleaning groups. Namely, the processing conditions are set for each lot and, thus, when the processing conditions of lots are included in the same cleaning group, it is determined that the same cleaning conditions are applied to the lots. On the other hand, when the processing conditions of lots are included in different cleaning groups, it is determined that different cleaning conditions are applied to the lots.

Further, the contents of the processing conditions and the cleaning conditions, and the contents of the cleaning condition data table can be updated by an operation of an operator using, e.g., the operation unit 330 or the like, or can also be updated from a host device (not shown) connected to the control unit 300 via a network (not shown) or the like.

### (Operation of Substrate Processing Apparatus)

Hereinafter, an operation of the substrate processing apparatus 100 configured as described above will be described. In the substrate processing apparatus 100 in accordance with this embodiment, 25 product wafers Wp of a lot are etched simultaneously in a plurality of plasma processing apparatuses. Here, there will be described an example in which product wafers Wp of a first lot a accommodated in the cassette container 134A are etched simultaneously in the plasma processing apparatuses PM₁, PM₂ and PM₃.

First of all, the process for controlling the inner states of the processing chambers is performed in order to stabilize the inner states of the processing chambers 210 of the plasma processing apparatuses PM₁, PM₂ and PM₃ prior to the etching process of the product wafers Wp. The process for controlling the inner states of the processing chambers is performed, after a plurality of (e.g., one to three) controlling wafers Wd are transferred into the processing chambers 210, based on a controlling recipe substantially the same as the etching conditions.

Accordingly, it is possible to control the temperature in the processing chamber or the amount of reaction products adhered to the inner wall of the processing chamber and the like, and also possible to make the inner state of the processing chamber 210 suitable for the following etching process. Further, the controlling wafers Wd are accommodated in the cassette container 134A in which the product wafers Wp are accommodated, and the same wafers as the product wafers Wp are used as the controlling wafers Wd.

Upon completion of the process for controlling the inner states of the processing chambers, the etching of the product wafers Wp is started. Since the plasma processing apparatuses PM₁, PM₂ and PM₃ are empty in an initial state, first to third product wafers Wp are sequentially transferred to the processing chambers 210. Specifically, the product wafers Wp are sequentially unloaded from the cassette container 134A and transferred to the respective processing chambers 210 via the load-clock chamber 114M and the common transfer chamber 112. Next, the etching is performed in the processing chambers 210 simultaneously.

The etching process in the processing chambers 210 is carried out based on the preset processing conditions. Specifically, the insides of the processing chambers 210 are depressurized, and a processing gas (e.g., a gaseous mixture containing C₄F₈ gas, O₂ gas and Ar gas) is introduced from the upper electrode 233 into the processing chambers 210 at a predetermined flow rate and flow rate ratio. At this time, the insides of the processing chambers 210 are maintained at a predetermined vacuum pressure by the APC valve 214 or the like. In this state, a high frequency power is applied from the high frequency power supply 218 to the susceptor 211 and, at the same time, a high frequency power is applied from the high frequency power supply 252 to the upper electrode 233. Accordingly, a plasma of the processing gas is generated in the plasma generating space S, and radicals or ions are produced by the plasma. As a result, the surfaces of the product wafers Wp are etched physically or chemically.

When the etching of the product wafers Wp is completed, the product wafers Wp are unloaded from the processing chambers 210 and then returned to the cassette container 134A via the common transfer chamber 112, the load-lock chamber 114N and the transfer chamber 130. At this time, the completion timings of the plasma processing apparatuses PM₁, PM₂ and PM₃ are different, so that next product wafers Wp are transferred to any of the plasma processing apparatuses PM₁, PM₂ and PM₃ which is available after the unloading of the product wafers Wp. Upon completion of the etching of the product wafers Wp of the first lot, etching of wafers of a next lot accommodated in the cassette container 134B is carried out.

However, while the etching of the product wafers Wp is consecutively performed, particles of the reaction products and the like are produced by the etching in the processing chambers 210 and then are gradually deposited on the sidewalls of the processing chambers 210 and the like. The particles may be peeled off and adhered to the next product wafers Wp during the processing of the next product wafers Wp. The adhesion of the particles to the product wafers Wp causes short circuit in wiring of the semiconductor devices formed on the product wafers Wp, and this may result in deterioration of the product yield.

Thus, in the substrate processing apparatus 100, at a predetermined timing, the cleaning wafers Wf are transferred to the processing chambers 210 and a cleaning process for removing particles from the processing chambers 210 is performed. The cleaning process is performed based on, e.g., preset cleaning conditions (cleaning recipe including e.g., pressures in the processing chambers, gas types, gas flow rates and the like). The cleaning process may be performed under the same conditions as, e.g., those of the etching process, or under different conditions. In this embodiment, the cleaning process is performed at a timing of switching lots.

### (Cleaning Process)

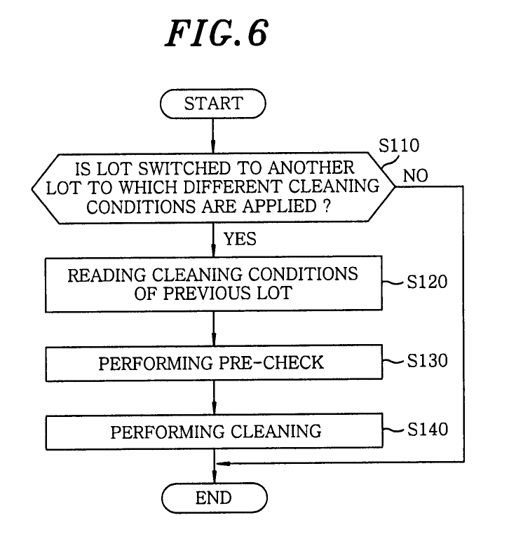

Hereinafter, the cleaning process of this embodiment will be described with reference to the drawings. FIG. 6 is a flowchart showing a specific example of the cleaning process in accordance with this embodiment. The cleaning process is carried out before wafers W of each lot are processed by the plasma processing apparatuses. First of all, it is determined in step S110 whether a lot is switched to another lot to which different cleaning conditions are applied. To be specific, it is determined whether a previous lot and a next lot belong to different cleaning groups based on the cleaning group data table shown in FIG. 5. If they belong to the different cleaning groups, it is determined that it is switched to a lot to which different cleaning conditions are applied. If they belong to the same cleaning groups, it is determined that it is switched to a lot to which the same cleaning conditions are applied.

If it is determined in the step S110 that a lot is switched to another lot to which different cleaning conditions are applied, the cleaning conditions of the previous lot are read out in step S120. This is because the cleaning needs to be performed under the cleaning conditions of the previous lot. The reason that the cleaning conditions of the previous lot are used instead of the cleaning conditions of the next lot is as follows. That is, the cleaning process is performed to remove the deposits deposited in the processing chamber 210 by the processing of the previous lot and, hence, high cleaning effects can be obtained by using the cleaning conditions of the previous lot.

Thereafter, in step S130, a pre-check is performed. In the pre-check, it is checked whether or not the processing chambers 210 can be cleaned normally. For example, the processing chambers 210 cannot be cleaned normally in states where the wafers W are being processed, the wafers W exist in the processing chambers 210, the wafers W are being unloaded from the processing chambers 210, the maintenance of the processing chambers 210 is being carried out, and the like. For example, it is determined that the wafers W are being processed in cases of introducing a processing gas, introducing a backgas for controlling a temperature of the wafers W or the like, controlling the electrode plate (electrostatic chuck) 220 for attracting and holding a wafer W, controlling a high frequency power supply, and the like. In addition, when the gate valves 240 of the processing chambers 210 are opened, it is determined that the wafers W are being loaded or unloaded. Further, when the covers of the processing chambers 210 are opened, it is determined that the maintenance is being carried out.

If it is determined by the pre-check in step S130 that the states in the processing chambers 210 are not suitable for the cleaning, the cleaning is completed in an error state (not shown). On the other hand, if it is determined in step S130 that the cleaning can be normally performed, the cleaning in the processing chambers is performed in step S140.

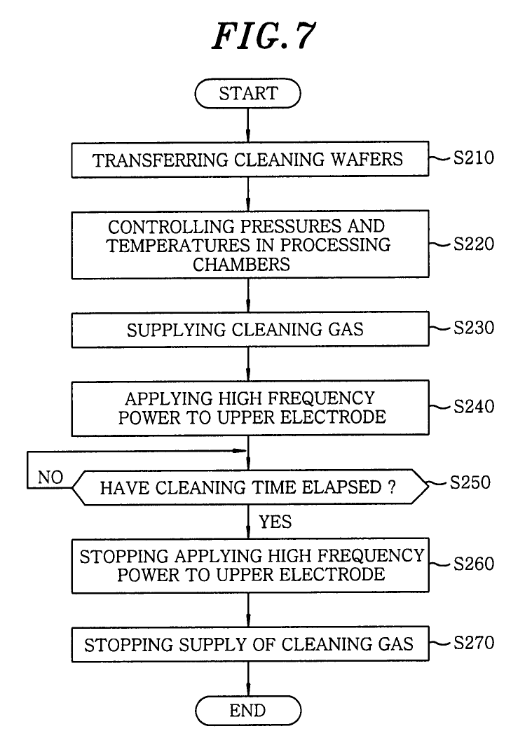

Hereinafter, a specific example of the contents of the cleaning process in step S140 will be described with reference to the flowchart of FIG. 7. First of all, in step S210, under control of the control unit 300, the cleaning wafers Wf are transferred into the processing chambers 210 where the cleaning will be carried out. Next, in step S220, the pressure in each of the processing chambers 210 is controlled to a predetermined vacuum pressure, e.g., 100 mTorr, by controlling the APC valve 214, the TMP 215 and the DP 216 and, also, the temperatures of the upper electrode 233, the susceptor 211 serving as the lower electrode and the inner walls of the processing chambers 210 are controlled to about 60° C., 60° C. and 20° C., respectively. Further, the susceptor 211 is set to the electrically floating state by switching the state of the switch 251. In the same manner, the electrode plate 220 is set to the electrically floating state by blocking the electrical connection between the DC power supply 222 and the electrode plate 220.

Next, in step S230, O₂ gas serving as a cleaning gas is supplied from the upper electrode 233 into the processing chamber 210. At this time, the gas flow rate is controlled to, e.g., 800 sccm. Thereafter, in step S240, a predetermined high frequency power of, e.g., 300 W is applied from the high frequency power supply 252 to the upper electrode 233.

Accordingly, the cleaning gas is converted to a plasma in the plasma generating space S in the processing chamber 210, and ions or radicals are produced. At this time, since the susceptor 211 is set to the electrically floating state, a high self-bias is not induced in the susceptor 211, and the ions are not strongly attracted to the susceptor 211. In other words, the ions collide with the top surface of the susceptor 211 with low kinetic energy, so that the top surface of the susceptor 211 is not eroded by the ions.

Meanwhile, the radicals that have reached the top surface of the susceptor 211 together with the ions are in contact with the reaction products deposited on the top surface of the susceptor 211, thereby generating other volatile reaction products. The volatile reaction products are easily separated (volatilized) from the top surface of the susceptor 211 and discharged to the outside of the processing chamber 210 via the main exhaust line or the temporary suction line. Accordingly, the top surface of the susceptor 211 and the like are cleaned and, further, the interior of the processing chamber 210 is cleaned.

Then, it is determined in step S250 that whether or not the cleaning time has elapsed. Here, the cleaning time is calculated based on the number of processed wafers W counted upon completion of the previous cleaning process. In this case, the cleaning time required for the processing of a predetermined number (e.g., 25) of wafers is preset, and the preset cleaning time is divided by the number of processed wafers W. Alternatively, the cleaning time required for the processing of a single wafer is preset, and the preset cleaning time is multiplied by the number of processed wafers W. Accordingly, the optimal cleaning time can be obtained. However, the cleaning time is not limited thereto, and may be set under the cleaning conditions.

If it is determined in step S250 that the cleaning time has elapsed, the supply of the high frequency power to the upper electrode 233 is stopped in step S260. Next, in step S270, the supply of O₂ gas serving as a cleaning gas into the processing chamber 210 is stopped. Further, the state of the switch 251 is switched so that the susceptor 211 and the high frequency power supply 218 are electrically connected to each other. After the processing chambers 210 are cleaned, the processing of a next lot is started.

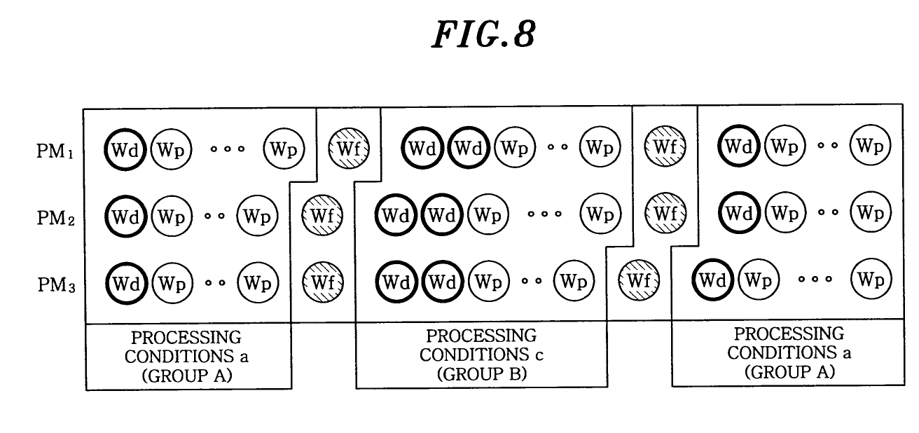

In accordance with the cleaning process of this embodiment, a plurality of lots are processed continuously and simultaneously by using the plasma processing apparatuses PM₁ to PM₃. For example, as illustrated in FIG. 8, when a lot of the processing conditions a is switched to a lot of the processing conditions c to which different cleaning conditions are applied, the cleaning wafers Wf are transferred to the processing chambers 210 and the interiors of the processing chambers 210 are cleaned prior to the processing of the lot of the processing conditions c. Next, also when the lot of the processing conditions c is switched to a lot of the processing conditions a to which different cleaning conditions are applied, the cleaning wafers Wf are transferred to the processing chambers 210 and the interiors of the processing chambers 210 are cleaned prior to the processing of the lot of the processing conditions a.

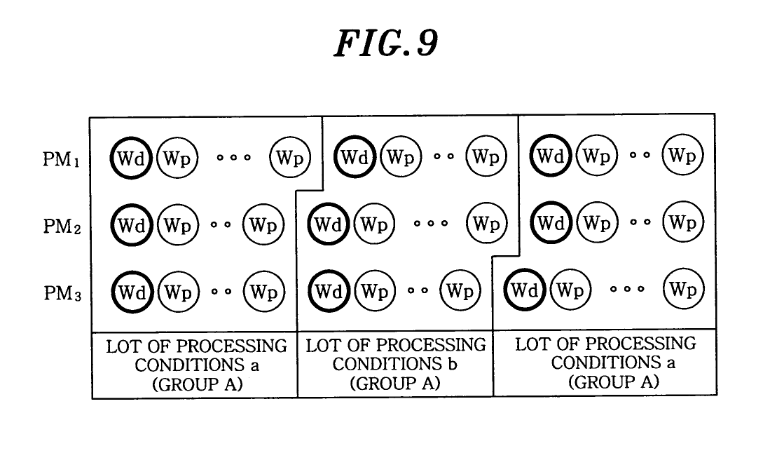

On the other hand, as shown in FIG. 9, when a lot of the processing conditions a is switched to a lot of the processing conditions b to which the same cleaning conditions are applied, the cleaning process is not carried out. Then, also when the lot of the processing conditions b is switched to a lot of the processing conditions a to which the same cleaning conditions are applied, the cleaning process is not performed.

Namely, the interiors of the processing chambers can be cleaned only when a lot is switched to another lot to which different cleaning conditions are applied. Accordingly, the cleaning can be performed at a proper timing. For example, when a lot is switched to another lot to which different cleaning conditions are applied as shown in FIG. 8, the processing conditions change. Therefore, it is preferable to reset the state in the processing chambers 210 by cleaning the interiors thereof. In this case, the cleaning is performed under the cleaning conditions of the previous lot, so that it is possible to reset the state in the processing chambers 210 accurately.

On the other hand, when a lot is switched to another lot to which the same cleaning conditions are applied as shown in FIG. 9, the processing conditions rarely change. Thus, it is unnecessary to reset the state in the processing chambers 210 by cleaning the interiors thereof. Further, when 25 product wafers Wp of a lot of the processing conditions a are processed continuously and simultaneously by the plasma processing apparatuses PM₁ to PM₃, seven to eight product wafers Wp are processed by each of the plasma processing apparatuses PM₁ to PM₃. Moreover, the same cleaning conditions are applied to a next lot and, thus, the processing conditions b rarely change.

Accordingly, if the cleaning is carried out when a lot is switched to another lot to which the same cleaning conditions are applied, the cleaning becomes excessive. In this embodiment, the cleaning process is not performed in this case to prevent the excessive cleaning. Further, since the number of cleaning processes can be reduced, a throughput increases.

Further, the cleaning time is set based on the number of times of the wafer processing counted upon completion of the previous cleaning process. Hence, the cleaning can be properly performed without becoming excessive or insufficient. Accordingly, even when any one of the plasma processing apparatuses PM₂₁ to PM₆ does not operate due to breakdown or the like, the proper cleaning process can be performed.

In other words, when any apparatus cannot operate, wafers are processed by another apparatus. In this case, the number of wafers processed by another apparatus increases. Therefore, if the cleaning time is fixed, the cleaning becomes insufficient. In this embodiment, however, the cleaning time can be set in accordance with the actual number of processed wafers, so that the cleaning can be properly performed without being excessive or insufficient even in this case.

As described above, the processing chambers 210 can be cleaned at a timing of switching lots. In addition, the cleaning wafers Wt may be transferred into the processing chambers 210 and the cleaning may be performed at a timing at which the number of times of the processing reaches a preset number (e.g., 25).

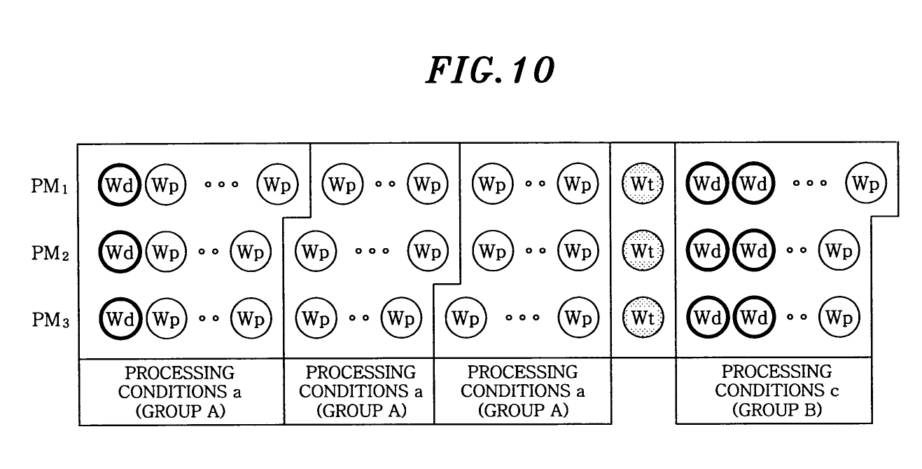

However, if the cleaning is performed in both cases, both timings may be overlapped. For example, when several lots of the same processing conditions a are continuously processed as shown in FIG. 10, the process (wafers Wd) for controlling the state in the processing chambers can be omitted. In this case, it is preferable to continue counting the number of times of the processing for the cleaning process even when a lot is switched to another lot. In this case, the cleaning is not performed at a timing of switching lots, so that the number of times of the processing can reach the preset number of times, i.e., 25. Therefore, if a lot is switched to another lot to which different cleaning conditions are applied after the number of times of the processing reaches 25 as shown in FIG. 10, the cleaning performed in accordance with the number of times of the processing overlaps with the cleaning performed at a timing of switching lots.

In this case, the cleaning process is performed, not in accordance with the timing of switching lots, but in accordance with the number of times of the processing. As a consequence, the excessive cleaning can be prevented.

Further, when the maintenance or the like is carried out while cutting off the power supply to the substrate processing apparatus 100, the cleaning conditions of a lot before the cut-off of the power supply are stored. When the substrate processing apparatus 100 is operated again, the cleaning is performed prior to the processing of a first lot under the cleaning conditions of the lot before the cut-off of the power supply. Therefore, the state in the processing chamber after the reoperation can be reset.

It is to be understood that the object of the present invention can also be attained by supplying to a system or an apparatus a storage medium storing a program of software that realizes the functions of the aforementioned embodiments, and then causing a computer (CPU or MPU) of the apparatus or the system to read out and execute the program stored in the storage medium.

In this case, the program itself read out from the storage medium realizes the functions of the aforementioned embodiments and, hence, the storage medium storing the program is included in the present invention. The storage medium for supplying the program may be, e.g., a floppy (registered trademark) disk, a hard disk, a magneto-optical disk, an optical disk, a CD-ROM, a CD-R, a CD-RW, a DVD-ROM, a DVD-RAM, a DVD-RW, a DVD+RW, a magnetic tape, a non-volatile memory card, a ROM or the like. Alternatively, the program may be downloaded via a network and then supplied to the medium.

Besides, it is to be understood that the functions of the aforementioned embodiments may be accomplished not only by executing the program read out by the computer, but also by causing an OS (operating system) or the like that runs on the CPU to perform a part or all of the actual operations based on instructions of the program.

Furthermore, it is to be understood that the functions of the aforementioned embodiments may also be accomplished by writing the program read out from the storage medium into a memory provided on a function extension board inserted into the computer or in a function extension unit connected to the computer, and then causing the CPU or the like provided on the function extension board or in the function extension unit to perform a part or all of the actual operations based on instructions of the program.

While the invention has been shown and described with respect to the embodiments, it will be understood by those skilled in the art that various changes and modification may be made without departing from the scope of the invention as defined in the following claims.

### INDUSTRIAL APPLICABILITY

The present invention is applicable to a cleaning method for cleaning an interior of a processing chamber installed in a substrate processing apparatus and a storage medium.

What is claimed is:

1. A cleaning method for cleaning processing chambers of a substrate processing apparatus for transferring substrates included in each of lots to the processing chambers on a lot basis and processing the substrates in the processing chambers simultaneously, the substrate processing apparatus including a storage unit for storing processing conditions of the lots and cleaning conditions set in accordance with the processing conditions, the method comprising:
checking whether a lot is switched to another lot to which different cleaning conditions are applied prior to the processing in the processing chambers;
performing a cleaning process on the processing chambers under cleaning conditions of a previous lot by transferring cleaning substrates into the processing chambers when it is determined that a lot is switched to another lot to which different cleaning conditions are applied; and
omitting the cleaning process of the processing chambers when it is determined that a lot is switched to another lot to which the same cleaning conditions are applied.

2. The cleaning method of claim 1, wherein the cleaning process is performed for a cleaning time calculated in accordance with the number of times of the processing of the substrates.

3. The cleaning method of claim 2, wherein the storage unit stores group data in which the processing conditions of the lots are classified into groups based on the cleaning conditions corresponding thereto, and
wherein whether a lot is switched to another lot to which different cleaning conditions are applied is determined depending on whether the processing conditions of the lots belong to different cleaning groups classified based on the group data.

4. The cleaning method of claim 1, wherein the cleaning process is performed, in addition to the cleaning process performed at a timing of switching lots, by transferring the cleaning substrates into the processing chambers at a timing at which the number of times of the processing performed in the processing chambers under the same processing conditions reaches a preset number.

5. The cleaning method of claim 2, wherein the cleaning process is performed, in addition to the cleaning process performed at a timing of switching lots, by transferring the cleaning substrates into the processing chambers at a timing at which the number of times of the processing performed in the processing chambers under the same processing conditions reaches a preset number.

6. The cleaning method of claim 3, wherein the cleaning process is performed, in addition to the cleaning process performed at a timing of switching lots, by transferring the cleaning substrates into the processing chambers at a timing at which the number of times of the processing performed in the processing chambers under the same processing conditions reaches a preset number.

7. The cleaning method of claim 4, wherein when the timing of the cleaning process performed at the timing of switching lots overlaps with the timing of the cleaning process calculated in accordance with the number of times of the processing, the cleaning process is performed at the timing calculated in accordance with the number of times of the processing without being performed at the timing of switching lots.

8. The cleaning method of claim 5, wherein when the timing of the cleaning process performed at the timing of switching lots overlaps with the timing of the cleaning process calculated in accordance with the number of times of the processing, the cleaning process is performed at the timing calculated in accordance with the number of times of the processing without being performed at the timing of switching lots.

9. The cleaning method of claim 6, wherein when the timing of the cleaning process performed at the timing of switching lots overlaps with the timing of the cleaning process calculated in accordance with the number of times of the processing, the cleaning process is performed at the timing calculated in accordance with the number of times of the processing without being performed at the timing of switching lots.

10. A computer readable storage medium storing a program for executing on a computer a cleaning method for cleaning processing chambers of a substrate processing apparatus for transferring substrates included in each of lots to the processing chambers on a lot basis and processing the substrates in the processing chambers simultaneously,
wherein the substrate processing apparatus includes a storage unit for storing processing conditions of the lots and cleaning conditions set in accordance with the processing conditions, and
wherein the method includes:
checking whether a lot is switched to another lot to which different cleaning conditions are applied prior to the processing in the processing chambers;
performing a cleaning process on the processing chambers under cleaning conditions of a previous lot by transferring cleaning substrates into the processing chambers when it is determined that a lot is switched to another lot to which different cleaning conditions are applied; and
omitting the cleaning process of the processing chambers when it is determined that a lot is switched to another lot to which the same cleaning conditions are applied.
